(19) United States
(12) Patent Application Publication
(10) Pub. No.: US 2008/0247785 A1
(43) Pub. Date: Oct. 9, 2008

(54) PATTERN FORMING APPARATUS AND PATTERN FORMING METHOD

(76) Inventors: Nobuo Kawamura, Fukaya-shi (JP); Makoto Onodera, Saitama-shi (JP); Sachiko Hirahara, Fukaya-shi (JP); Toshio Ioi, Ibo-gun (JP); Koichi Ishii, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/056,053

(22) Filed: Mar. 26, 2008

Related U.S. Application Data
(63) Continuation of application No. PCT/JP2008/051296, filed on Jan. 29, 2008.

(30) Foreign Application Priority Data
Feb. 6, 2007 (JP) 2007-027123

(51) Int. Cl. G03G 15/08; G03G 13/04; G03G 21/00

(52) U.S. Cl. 399/265; 430/48; 399/343

(57) ABSTRACT

A pattern forming apparatus brings a masking panel having a pattern-like through hole into tight contact with the inside surface of a front panel, and positions the through hole to the inside of a recess of the front panel. In this state, liquid developer is supplied through a developing roller, and an electric field passing through a developing recess where the recess and through hole are continued. Therefore, charged developer particles are collected in the developing recess, and the recess of the front panel is developed.

### CROSS REFERENCE TO RELATED APPLICATIONS

This is a Continuation Application of PCT Application No. PCT/JP2008/051296, filed Jan. 29, 2008, which was published under PCT Article 21(2) in Japanese.

This application is based upon and claims the benefit of priority from prior Japanese Patent Application No. 2007-027123, filed Feb. 6, 2007, the entire contents of which are incorporated herein by reference.

### BACKGROUND OF THE INVENTION

1. Field of the Invention

The present invention relates to a pattern forming apparatus and method used for manufacturing a planner image display, a wiring substrate and an IC tag, for example.

2. Description of the Related Art

Photolithography has been mainly used as a conventional technique for forming a fine pattern on a surface of a base material. However, photolithography requires huge costly production facilities, though it increases resolution and performance. Further, it is difficult to reuse coating materials except a pattern, and it is difficult to reduce the cost required for forming a pattern.

In contrast, for example, an ink-jet technique has become practical as a low-cost patterning technique, because of its simple configuration and non-contact patterning. However, it is difficult for even such an ink-jet technology to increase resolution and productivity.

In the circumstances, electrophotography, particularly using liquid toner, is regarded to have an excellent possibility.

A method of forming a fluorescent layer, a black matrix or a color filter of a front substrate for a flat-panel display by using such electrophotography has been proposed. For example, as an apparatus for forming a fluorescent screen on a front substrate of a planner image display, there has been proposed an image forming apparatus, which forms a pattern-like static latent image on the surface of a photoconductive drum, develops the latent image by supplying a charged developer, transfers such a developer image of each color sequentially to a transfer drum, and transfers and fixes these color images overlapped on the transfer drum collectively on a substrate (e.g., Jpn. Pat. Appln. KOKAI Publication No. 2004-30980 [FIG. 4]).

However, in such an apparatus using two or more drums, a pattern-like developer image formed on a curved peripheral surface of a photoconductive drum is transferred to a curved peripheral surface of a transfer drum, and this pattern on peripheral surface of the transfer drum is transferred to a planer substrate. Thus, it is very difficult to keep a high positioning accuracy between the positions of the photoconductive drum and transfer drum, and between the positions of the transfer drum and substrate. It is also very difficult to form a fine pattern on a substrate.

Further, in this pattern forming apparatus, as a pattern is formed on a substrate, many steps are required, a processing time becomes long, a processing efficiency is poor, and a cost is increased.

### BRIEF SUMMARY OF THE INVENTION

It is an object of the invention to provide a pattern forming apparatus and method, which are configured to simplify the apparatus configuration, reduce the number of pattern forming steps, and form a fine pattern with a high positioning accuracy in a short time.

In order to achieve the above object, a pattern forming apparatus according to the invention comprises a masking panel which has a pattern-like through hole corresponding to a printing pattern to be formed on the surface of a printing medium, and is opposed closely to the surface; and a developing unit which supplies liquid developer with charged developer particles dispersed in insulating liquid to the backside of the masking panel remote from the printing medium, forms an electric field passing through the through hole, collects the developer particles in the through hole, and develops the printing pattern on the surface of the printing medium.

Further, a pattern forming method according to the invention comprises an opposing step of opposing a masking panel having a pattern-like through hole corresponding to a printing pattern to be formed on the surface of a printing medium, closely to the surface, and a developing step of developing the printing pattern on the surface of the printing medium, by supplying liquid developer with charged developer particles dispersed in insulating liquid to the backside of the masking panel remote from the printing medium, forming an electric field passing through the through hole, and collecting the developer particles in the through hole.

According to the invention, as a printing pattern is developed by supplying liquid developer to the surface of a printing medium through a masking panel having a pattern-like through hole, and collecting developer particles in a through hole by an electric field, the configuration of the apparatus is simplified, the number of steps required for forming a pattern is reduced, a pattern is formed in a relatively short time, and a cost is decreased. Further, as a printing pattern is directly developed on a printing medium through a pattern-like through hole, a fine pattern is formed with a high positioning accuracy.

### BRIEF DESCRIPTION OF THE SEVERAL VIEWS OF THE DRAWING

FIG. 1 is a block diagram showing a pattern forming apparatus according to an embodiment of the invention;

FIG. 2 is a block diagram showing a control system of the pattern forming apparatus of FIG. 1;

FIG. 3 shows a partially enlarged sectional view of a front panel to be set in the pattern forming apparatus of FIG. 1, and a plan view of the front panel viewed from a masking panel side;

FIG. 4 shows a partially enlarged sectional view of the masking panel of the pattern forming apparatus of FIG. 1 opposed to the front panel, and a bottom view of the masking panel viewed from a backside;

FIG. 5 is a flowchart for explaining the operation of the pattern forming apparatus of FIG. 1;

FIG. 6 is a perspective view for explaining a method of positioning a masking panel and front panel;

FIG. 7 is a partially enlarged sectional view showing the contacted closely front panel and masking panel;

FIG. 8 is a view for explaining the operation of a developing unit;

FIG. 9 is a partially enlarged sectional view for explaining the developing operation of a developer; and

FIG. 10 is a view for explaining the operation of a cleaning mechanism.

### DETAILED DESCRIPTION OF THE INVENTION

A pattern forming apparatus according to an embodiment of the invention will be explained in detail hereinafter with reference to the accompanying drawings. As an example of a pattern forming apparatus, a pattern forming apparatus 100 will be explained. The pattern forming apparatus 100 prints a fluorescent screen on the inside surface of a front panel of a planner image display, such as a liquid crystal display and a plasma display.

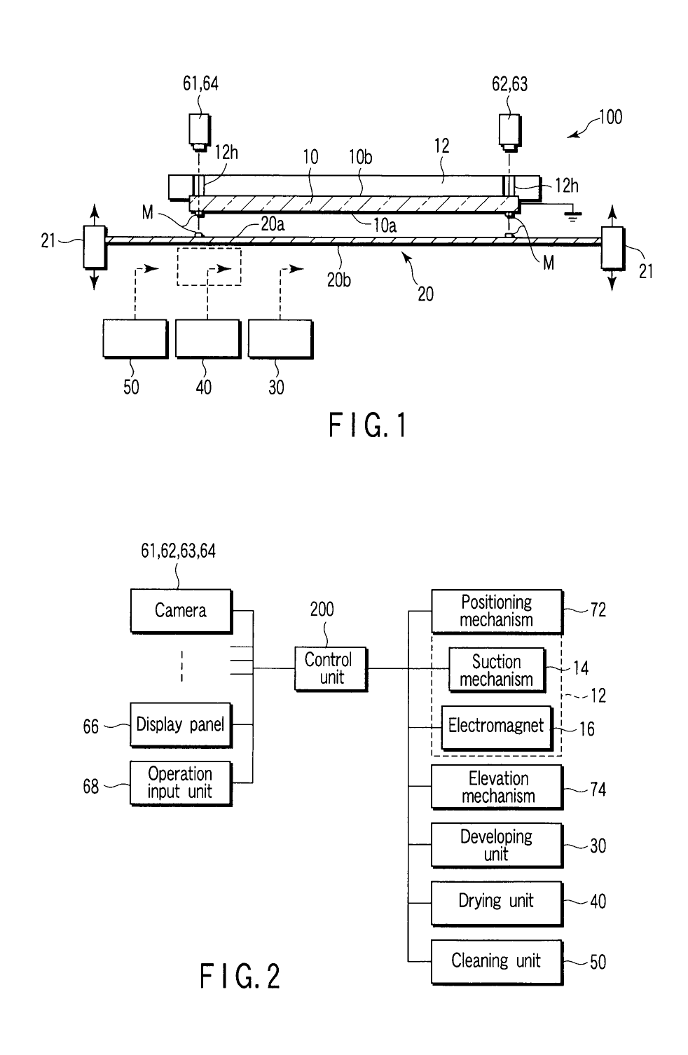

As shown in FIG. 1, the pattern forming apparatus 100 has a suction plate 12 to absorb and hold a backside 10b of a front panel 10 (a printing medium), a masking panel 20 placed horizontally below the front panel 10, and three units (a developing unit 30, a drying unit 40, and a cleaning unit 50) provided below the masking panel movably in the horizontal direction.

Three units 30, 40 and 50 are provided movably at a variable speed in the direction parallel to and approaching/separating from the masking panel, as indicated by a broken line in the drawing. The developing unit 30 shown on the right side of the drawing functions as a developing apparatus, the drying unit 40 shown at the center functions as a drying mechanism, and the cleaning unit 50 shown on the left side functions as a cleaning mechanism in the present invention. The front panel 10 may be moved in the horizontal direction, instead of moving the three units 30, 40 and 50 along the front panel.

As shown in FIG. 2, a control unit 200 to control the operation of the pattern forming apparatus 100 is connected to four positioning cameras 61, 62, 63 and 64, a display panel 66 to display images taken by these cameras to an operator, an operation input unit 68 to accept various operations input by the operator, a positioning mechanism 72 to hold and move the suction plate 12 in the surface direction for positioning the front panel 10 with respect to the masking panel 20, an elevation mechanism 74 to hold and move up/down a square frame 21 with the masking panel 20 extended inside in the direction of approaching/separating the masking panel 20 to/from the front panel 10, a suction mechanism 14 to produce a sucking force to the front panel 10 to produce a holding force by the suction plate 12, an electromagnet 16 to produce a magnetic force to attract the inside surface 10a of the front panel 10 to closely contact the inside surface 20a of the masking panel 20, and three units 30, 40 and 50.

The suction mechanism 14 may be configured to enable the suction plate 12 to suck the panel 10 by applying a static force to the backside 10b of the front panel 10, or by applying a negative pressure to the backside 10b of the front panel 10 from the suction plate 12. The electromagnet 16 is built into the suction plate 12, and functions as a tight contacting mechanism to bring the front panel 10 tightly into contact with the masking panel 20, by holding the front panel 10 between the suction plate 12 and masking panel 20, by applying a magnetic force to the masking panel 20 including a part made of a magnetic substance, through the front panel 10.

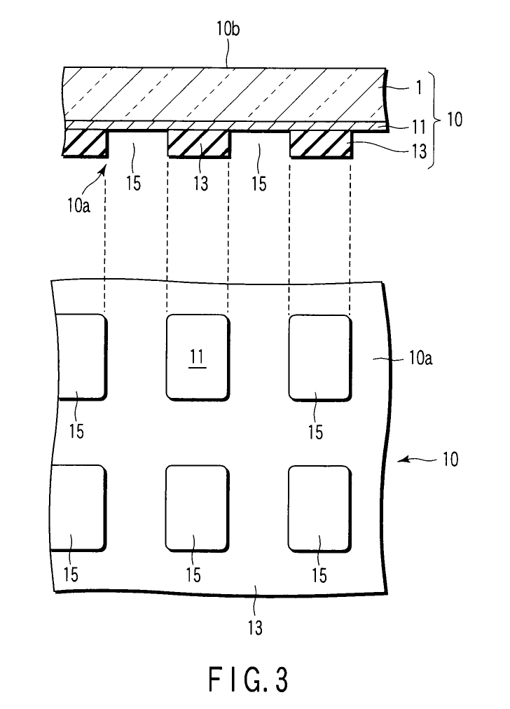

As partially enlarged in FIG. 3, the front panel 10 has a transparent electrode layer 11 and a grid-shaped black matrix 13 on the surface of a square glass plate 1. In other words, on the inside surface 10a of the front panel 10, a number of substantially square concaves 15 is formed and arranged as a matrix to form three color fluorescent layers partitioned by the black matrix 13. Namely, each recess 15 corresponds to one pixel of the display, and the electrode layer 11 is provided at the bottom. The electrode layer 11 is grounded as shown in FIG. 1.

The electrode layer 11 is formed by spraying Denatrron G-115S of Nagase ChemteX to the surface of the glass plate 1, and drying the surface to form a film with a thickness of 0.2 μm. Or, the electrode layer 11 may be made of inorganic material, such as a sputter film of antimony oxide.

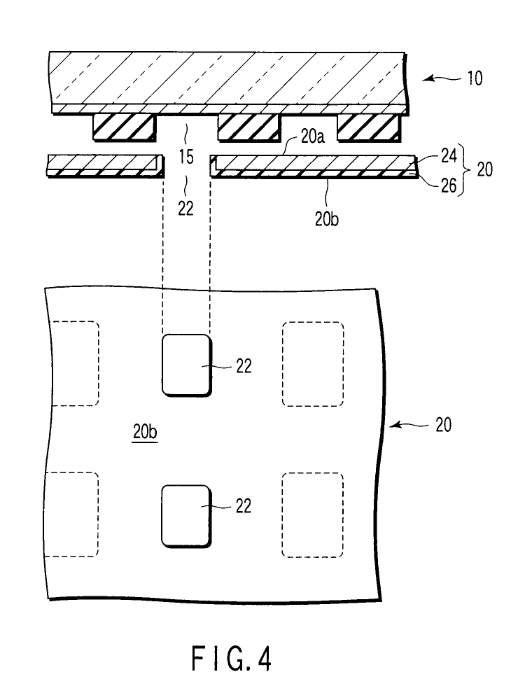

As partially enlarged in FIG. 4, the masking panel 20 has pattern-like through holes 22 corresponding to a printing pattern 15 of three color fluorescent layers formed on the front panel. In this embodiment, as three color fluorescent layers are printed one by one on the inside surface 10a of the front panel 10 by using the masking panel 20, the masking panel 20 has through holes 22 of one third of the number of recesses 15 formed on the inside surface 10a. However, when another pattern such as a semiconductor substrate is printed at one time, the shape of a through hole of the masking panel becomes the shape substantially identical to the printing pattern. One through hole 22 has an aperture area smaller than that of the recess 15 formed on the inside surface 10a of the front panel 10.

In this embodiment, after a first color fluorescent layer is printed, the masking panel 20 is cleaned if necessary, and then the masking panel 20 is moved in the surface direction relatively to the front panel 10 just like shifting one color, and operated to print the next color fluorescent layer. Therefore, the masking panel 20 has through holes 22 of only one third of the number of recesses 15 formed on the inside surface 10a of the front panel 10. When the cleaning step is omitted, the masking panel 20 has to be prepared for three colors.

In the masking panel 20 of this embodiment, an insulating coat layer 26 with a thickness of 10 μm can be formed by spraying insulating paint to the backside 20b, after opening a hole by photo-etching an Ni—Fe alloy plate 24 with a thickness of 50 μm. The insulating coat layer 26 covers the whole backside of the masking panel 20, reaches into the through hole 22, and covers the inside wall. The masking panel 20 is acceptable, as long as it includes a material attracted by the magnet 16, and the surface is coated with a high-resistance chargeable material, and is not limited to the structure of this embodiment. The masking panel 20 may be made of a high-resistance chargeable material. A mold release agent may be coated on the surface of the masking panel 20 to increase the ease of releasing developer particles described later.

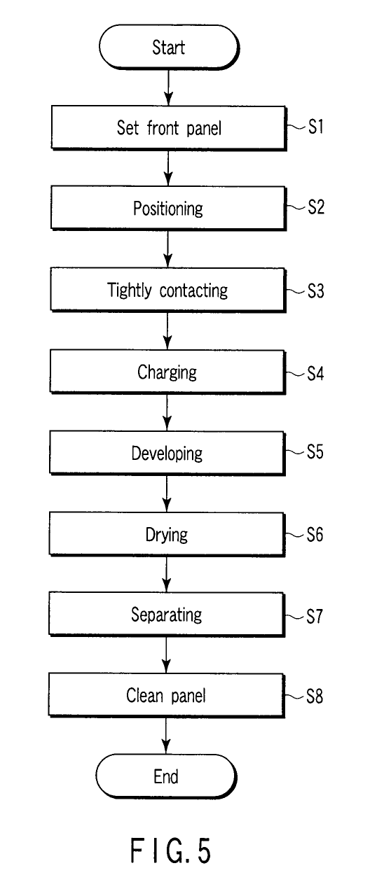

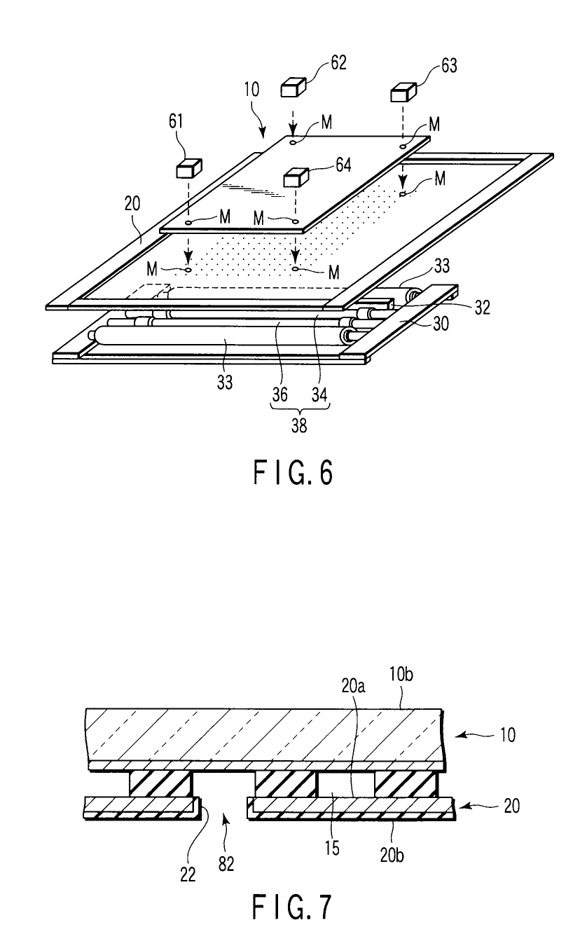

Next, an explanation will be given on the pattern forming operation by the pattern forming apparatus 100 configured as described above, with reference to the flowchart of FIG. 5 and to FIGS. 6 to 9.

First, prepare the front panel 10 having the electrode layer 11 and black matrix 13 previously formed on the surface of the glass plate 1. Let the suction plate 12 suck the backside 10b of the front panel 10, and set the suction plate 12 in the positioning mechanism 72 (FIG. 5, step 1). At this time, the suction plate 12 is fit to the positioning mechanism 72 with the inside surface 10a of the front panel 10 faced down. Therefore, the inside surface 10a of the front panel 10 is opposed to the inside surface 20a of the masking panel 20. At this time, there is a clearance between the inside surface 10a of the front panel 10 and the inside surface 20a of the masking panel 20 (e.g., the state of FIG. 4).

In this state, as shown in FIG. 6, images taken by four cameras 61, 62, 63 and 64 are displayed through the display panel 66, the positioning mechanism 72 is operated by the operator who watches the displayed images, the front panel 10 is moved in the surface direction, and positioning is performed (step 2). Namely, as shown in FIG. 1 and FIG. 6, a positioning mark M is previously formed at four corners of the front panel 10, and a through hole 12h (FIG. 1) is formed at a part corresponding to the suction plate 12 omitted in FIG. 6. By detecting the mark M of the front panel 10 and the positioning mark M corresponding to the masking panel 20 in being overlapped, detect displacements of the front panel 10 and masking panel 20 in the surface direction, and performs positioning of the front panel 10 and masking panel 20 in the surface direction by the positioning mechanism 72.

Namely, in the positioning process of step 2, the front mask 10 is relatively roughly aligned with the masking panel 20, so that the through hole 22 of the masking panel 20 is positioned inside the recess 15 of a color to be developed on the front panel 10 (the state of FIG. 7), when the front panel 10 and masking panel 20 are brought into tight contact in the tight contacting step to be described later.

After the positioning in step 2, the elevation mechanism 74 is operated, the masking panel 20 is moved up to the inside surface 10a of the front panel 10, and the inside surface 10a of the front panel 10 is brought into tight contact with the inside surface 20a of the masking panel 20 (FIG. 7). At this time, the electromagnet 16 built in the suction plate 12 is turned on, and the masking panel 20 including a magnetic material is attracted to the inside surface 10a of the front panel 10 (step 3). When the masking panel 20 is made of a high-resistance material, a sufficient absorbing force is not produced even by mixing a magnetic material. Therefore, in this case, a frame-like holding means made of magnetic substance may be arranged outside a pattern forming area on the backside 20b of the masking panel 20.

The masking panel 20 is composed of a thin metal plate as described above, and as the panel size is increased, the panel bends much more when placed horizontally. The masking panel 20 does not completely contact the front panel 10, when it is simply moved up by the elevation mechanism 74. Thus, in this embodiment, the magnetic force of the electromagnet 16 is used to realize tight contact between the inside surface 20a of the masking panel 20 and the inside surface 10a of the front panel 10. This state is shown partially enlarged in FIG. 7.

Namely, as shown in FIG. 7, when the electromagnet 16 is turned on and the inside surface 10a of the front panel 10 tightly contacts the inside surface 20a of the masking panel 20, the recess 15 formed on the inside surface 10a of the front panel 10 positioned in step 2 is connected to the through hole 22 of the masking plate 20, forming a developing recess 82 where the through hole and recess are continued. Of course, the recess 15 opposed to the part of the masking panel 20 having no through hole 22 is closed by the inside surface 20a of the masking panel 20.

In this embodiment, for a developing process described later, when the front panel 10 is brought into tight contact with the masking plate 20 as shown in FIG. 7, the through hole 22 of the masking plate 20 needs to be placed inside the corresponding recess 15 of the front panel 10. However, as the aperture of the through hole 22 is set smaller than the aperture of the recess 15, the accuracy can be decreased in the positioning of step 2. Namely, even if the positioning accuracy is decreased by some extent, there occurs no problem, as long as the through hole 22 is fit inside the corresponding recess 15.

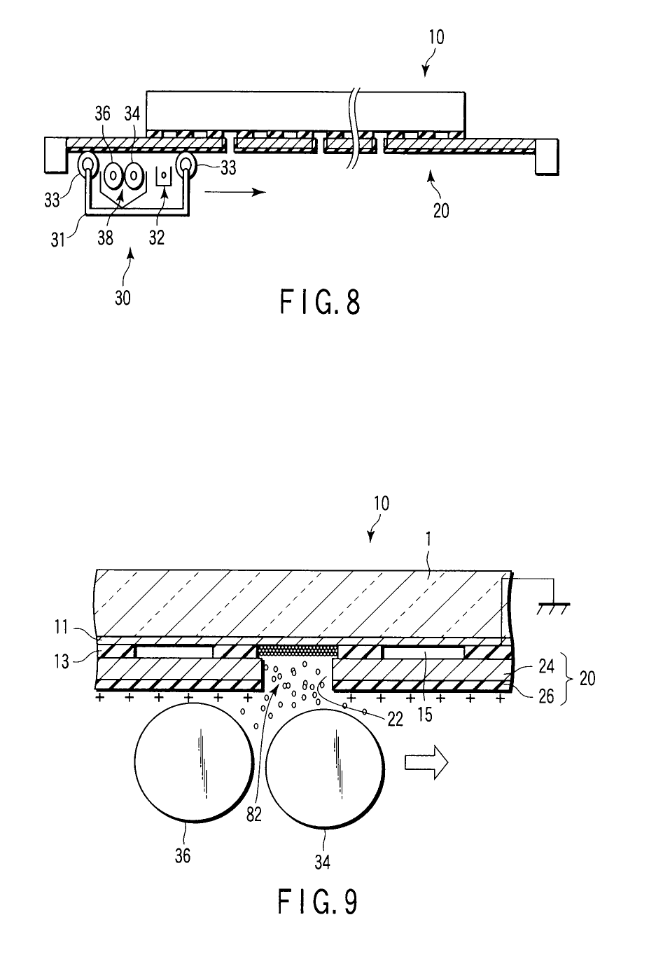

Thereafter, the control unit 200 operates the developing unit 30 shown in FIG. 8, and charges the insulating coat layer 26 covering the backside 20b of the masking panel 20 to the same polarity as the developer particle (step 4). In this embodiment, a corona charger 32 is used as a charging unit. Here, the charging process of step 4 is performed after the tight contacting process of step 3, but the charging process may be performed at any timing before the tight contacting process. In this embodiment, the surface of the insulation coat surface 26 is charged to 400V in the charging process of step 4.

As shown in FIG. 8, the developing unit 30 has a case 31 opened to the backside 20b of the masking panel 20. As shown in FIG. 6, the developing unit 30 has substantially the same width as the masking panel 20. In the upper edge portions of the opening of the case 31, two pressing rollers 33 (a tight contacting mechanism and a pressing member) extended in the width direction orthogonal to the moving direction (in the direction of the arrow in FIG. 8) are provided to be rotatable. When the developing unit 30 is moved in the direction of arrow in FIG. 8, these pressing rollers 33 are pressed to the backside 20b of the masking panel 20, and contacts the backside 20b while rolling. Therefore, in the developing area where the developing unit 30 passes, the masking panel 20 is brought into tight contact with the front panel 10 by a stronger force.

In the case 31 of the developing unit 30, a developing unit 38 containing a developing roller 34 (a supplying member) and a squeezing roller 36 (an removing member) is provided in addition to the corona charger 32. The developing unit 38 extends in the width direction, and covers the total width of a pattern forming area. FIG. 9 shows the developing roller 34 and squeezing roller 36 of the developing unit, in a partially enlarged manner. The developing roller 34 and squeezing roller 36 are opposed to the backside 20b of the masking panel 20 with certain gaps taken between them.

Subsequent to the charging process of step 4, one color recess 15 out of all recesses 15 of the front panel 10 is developed (step 5). In this embodiment, as the developing unit 30 contains the corona charger 32 and developing unit 38 in the case 31, the charging step and developing step are performed substantially at the same time.

In the developing process of step 5, the liquid developer supplied from a not-shown supply system is supplied to the backside 20b of the masking panel 20 through the peripheral surface of the rotating developing roller 34. At this time, a developing bias is applied to the developing roller 34, and a potential difference is produced between the developing roller 34 and the electrode layer 11 of the front panel 10. Namely, as the electrode layer 11 of the front panel 10 is grounded as describer hereinbefore, and a positive voltage is applied to the developing roller 34, an electric field toward the developing recess 82 acts on positively charged developer particles. Therefore, the developer particles dispersed in the liquid developer migrate in the insulating liquid, and are collected in the developing recess 82. In this embodiment, a bias voltage of 300V is applied to the developing roller 34 in the developing process of step 5.

At this time, the surface of the insulating coat layer 26 covering the backside 20b of the masking panel 20 and the inside surface of the through hole 22 are also charged to the same polarity as the developer particles in the charging step, and the migrating developer particles are not deposited on the surface of the masking panel 20. At this time, the amount of developer particles collected and filled in the recess 15 can be controlled by controlling the developing bias. Otherwise, the amount of the developer particles to develop the recess 15 can be controlled by controlling the density of the developer particles in the liquid developer or the moving speed of the developing unit 30.

At this time, the squeezing roller 36 of the developing unit is rotated in the reverse direction, and a part of the insulating liquid is collected together with surplus developer particles. The squeezing roller 36 is subjected to a voltage of the same polarity as the developer particle at a potential lower than the developing roller 34, and an electric field toward the electrode layer 11 of the recess 15 from the squeezing roller 36 is produced. Therefore, the developer particles collected in the recess 15 are coagulated more strongly, and the surplus developer particles floating in the insulating liquid are deposited on the surface of the squeezing roller 36. In this embodiment, the squeezing roller 36 is subjected to a voltage of 200V in the developing process of step 5.

When the liquid developer is supplied to the backside 20b of the masking panel 20, the liquid developer is evenly supplied to the recess 15 of the front panel 10 continued to the through hole 22, i.e., the developing recess 28, and the developer particles can be supplied to every corner of the recess 15 by electrophoresis. Therefore, by adopting the pattern forming method of this embodiment, it is possible to form a printing pattern with the shape substantially identical to the shape of the recess 15. Namely, the present invention is effective when fluorescent particles are deposited on the inside surface of a rib structure formed on a front panel of a plasma display, for example.

Further, in this developing process, it is important to bring the masking panel 20 into tight contact with the front panel 10. Namely, if there is a clearance between the surface 20a of the masking panel 20 and the surface 10a of the front panel 10, the liquid developer flows into this clearance, and the contour of a printing pattern formed on the front panel 10 becomes blurred. Therefore, in the present invention, the electromagnet 16 is used to bring the front panel 10 into tight contact with the masking panel by a magnetic force, and the pressing roller 33 of the developing unit 30 is pressed to the backside 20b of the masking panel 20, so that the front panel 10 and masking panel 20 are brought into tight contact at least in the developing area.

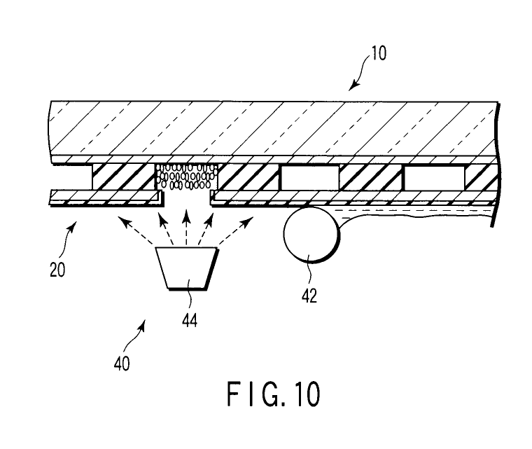

After the developing process of step 5, the control unit 200 operates the drying unit 40 shown in FIG. 10, and dries the insulating liquid of the liquid developer supplied to the backside 20b of the masking panel 20 in step 5 (step 6). At this time, first the sponge 42 is brought into contact with the backside 20b of the masking panel 20, and the most of the insulating liquid is absorbed by the sponge 42. Then, air is blown to the backside 20b of the masking panel 20 through a drier 44, and the remained insulating liquid is dried. It is allowed to suck most of the insulating liquid by using a suction unit having a suction nozzle, instead of the sponge 42. In this case, it is allowed to apply an electric field so that the developer particles in the developing recess 82 are not absorbed. It is also permitted to dry the insulating liquid to a desired state by blowing air by the dryer 44, not by using the sponge 42 or suction nozzle.

After the insulating liquid is dried in step 6, the control unit 200 operates the elevation mechanism 74, moves down the masking panel 20 (the frame 21) in the direction of separating from the front panel 10, and separates the front panel 10 from the masking panel 20 (step 7). At this time, it is desirable to separate the masking panel 20 gradually at a low speed from the front panel 10. It is also desirable to separate the masking panel 20 by gradually inclining one end of the masking panel 20. Further, as the insulating liquid wetting the structure of the masking panel 20 and front panel 10 has been dried to some extent in the drying process of step 6, the developer particles are not dispersed by the flow of insulating liquid in the separating process of step 7, and the developer particles will not be destroyed after development.

Finally, the control unit 200 operates the cleaning unit 50, and cleans the liquid developer remained in the masking panel 20 separated from the front panel 10 (step 8). At this time, a cleaning liquid is sprayed to the masking panel 20 from both inside side 20a and backside 20b, through a not-shown nozzle. This cleaning process of step 8 is not absolutely necessary, and may be executed as required. For example, in the case of pattern printing not requiring multicolor printing, it is unnecessary to clean the panel. Further, in this cleaning process, it is also possible to clean the masking panel 20 by flushing the cleaning liquid like a shower, or by using a brush or ultrasonic waves.

The masking panel 20 cleaned in the cleaning process of step 8 is used for forming the next color fluorescent layer on the surface 10a of the front panel. At this time, the positioning mechanism 72 is operated by observing the mark M taken by the cameras 61, 62, 63 and 64 through the display panel, the front panel 10 is moved a little in the surface direction, and the front panel 10 is displaced only by one pixel from the masking panel 20. The next color pattern is formed by using the liquid developer including the next color developer particles.

As described above, according to this embodiment, as a pattern is directly formed on the front panel 10 by the liquid developer through the masking panel 20 having the pattern-like trough hole 22, the number of steps required for forming a pattern can be minimized, the apparatus configuration can be simplified, the amount of developer can be minimized, and the cost required for forming a pattern can be minimized. Further, as the configuration of the pattern forming apparatus can be simplified, the apparatus installation space can be reduced. As the number of steps for forming a pattern is reduced, the processing time required by forming a pattern can be reduced to a minimum, the processing efficiency can be increased, and the cost can be reduced.

Moreover, the pattern forming method according to this embodiment develops developer particles in the recess 15 of the front panel 10 through the masking panel 20, and the method is suitable for forming a relatively thick pattern such as a fluorescent layer, and sufficiently applicable to a pattern with an increased fineness. Photolithography is usable when the recess 15 is formed on the inside surface of the front panel 10, and a pattern depending on the position and shape of the recess 15 can be finely formed.

The present invention is not to be limited to the embodiment described herein. The invention may be embodied by deforming the components in a practical stage without departing from the spirit and essential characteristics. The invention may be embodied by appropriately combining two or more components disclosed in the embodiment described herein. For example, some components may be deleted from the components shown in the embodiment.

For example, in the embodiment explained herein, a fluorescent layer is patterned on the front panel 10 of a planner image display. The invention is not to be limited to this. The invention is applicable to the case of patterning a black matrix or a color. The pattern forming apparatus and method according to the invention can be used for patterning of a semiconductor substrate or manufacturing an IC tag.

Further, in the embodiment disclosed herein, a masking panel, having a pattern-like through hole corresponding to a printing pattern to be printed on a printing medium (the front panel 10), is used. This term “corresponding to” includes the case where a printing pattern coincides with a pattern of through holes. Namely, when recess 15 is not formed as a pattern on the surface of a printing medium, the shape of the through hole 22 of the masking panel 20 becomes the shape of a printing pattern.

In contrast, the term “corresponding to” is applicable to the through hole 22 having an aperture smaller than the contour of a printing pattern (i.e., the recess 15), as in the embodiment disclosed herein. Namely, as shown in FIG. 7, if the aperture of the through hole 22 fits inside the recess 15 when the front panel is closely contacted to the masking panel 20, a pattern can be normally formed. Further, the shape of the aperture of the through hole 22 needs not to be square to meet the shape of the recess 15, and may be round, for example.

When the shape of the recess 15 is not shaped like a dot as in the embodiment, but shaped more complex just like a wiring pattern, through holes are provided at positions separated along a pattern, and liquid developer may be supplied to these through holes. Liquid developer flows in the recess and reaches every, and the shape of a through hole has a relatively high degree of flexibility. In other words, when an aperture of a through hole is positioned inside a pattern recess, a high positioning accuracy is unnecessary as described herein.

The pattern forming apparatus according to the present invention has the configuration and function as described herein. Therefore, the apparatus configuration can be simplified, the number of pattern forming steps can be decreased, and a fine pattern can be formed with a high positioning accuracy at a low cost and in a short time.

What is claimed is:

1. A pattern forming apparatus characterized by comprising:
a masking panel which has a pattern-like through hole corresponding to a printing pattern to be formed on the surface of a printing medium, and is opposed closely to the surface; and
a developing unit which supplies liquid developer with charged developer particles dispersed in insulating liquid to the backside of the masking panel remote from the printing medium, forms an electric field passing through the through hole, collects the developer particles in the through hole, and develops the printing pattern on the surface of the printing medium.

2. The pattern forming apparatus according to claim 1, characterized in that the developing unit has a supplying member to supply the liquid developer, and an removing member to remove surplus developer particles.

3. The pattern forming apparatus according to claim 1, characterized by further comprising a positioning mechanism which positions the printing medium and the masking panel by moving relatively in the surface direction.

4. The pattern forming apparatus according to claim 3, characterized by further comprising a tight contacting mechanism which makes tight contact between the printing medium and the masking panel.

5. The pattern forming apparatus according to claim 4, characterized in that the tight contacting mechanism has a magnet to closely contact the printing medium and masking panel by a magnetic force.

6. The pattern forming apparatus according to claim 4, characterized in that the tight contacting mechanism has a pressing member to press the printing medium to the masking panel in a developing area of the developing unit.

7. The pattern forming apparatus according to claim 1, characterized by further comprising a charging unit which charges the masking panel to the same polarity as the developer particles to prevent adhesion of the developer particle to the masking panel.

8. The pattern forming apparatus according to claim 1, characterized in that the surface of the masking panel is coated with a mold release agent to increase the easiness of releasing the developer particles.

9. The pattern forming apparatus according to claim 1, characterized by further comprising a drying mechanism for drying insulating liquid included in the liquid developer supplied from the developing unit.

10. The pattern forming apparatus according to claim 9, characterized in that the drying mechanism has a suction unit to suck the insulating liquid by air.

11. The pattern forming apparatus according to claim 9, characterized in that the drying mechanism has a sponge to absorb the insulating liquid.

12. The pattern forming apparatus according to claim 9, characterized in that the drying mechanism has a dryer to dry the insulating liquid by blowing air.

13. The pattern forming apparatus according to claim 1, characterized by further comprising a cleaning mechanism for cleaning the masking panel after development by the developing unit.

14. The pattern forming apparatus according to claim 1, characterized in that a pattern-like recess substantially identical to a desired pattern is formed on the surface of the printing medium, and the pattern-like through hole of the masking panel has an aperture smaller than the aperture of the recess.

15. A pattern forming method characterized by comprising:
an opposing step of opposing a masking panel having a pattern-like through hole corresponding to a printing pattern to be formed on the surface of a printing medium, closely to the surface, and
a developing step of developing the printing pattern on the surface of the printing medium, by supplying liquid developer with charged developer particles dispersed in insulating liquid to the backside of the masking panel remote from the printing medium, forming an electric field passing through the through hole, and collecting the developer particles in the through hole.

16. The pattern forming method according to claim 15, characterized in that the opposing step includes a positioning step of positioning the printing medium and the masking panel by moving relatively in the surface direction.

17. The pattern forming method according to claim 16, characterized by further comprising a tight contacting step of tightly contacting the printing medium and the masking panel, before the developing step.

18. The pattern forming method according to claim 15, characterized by further comprising a charging step of charging the masking panel to the same polarity as the developer particles, before the developing step.

19. The pattern forming method according to claim 15, characterized by further comprising a drying step of drying insulting liquid included in the liquid developer supplied in the developing step, after the developing step.

20. The pattern forming method according to claim 19, characterized by further comprising a separating step of separating the masking panel from the printing medium, after the drying step.

21. The pattern forming method according to claim 20, characterized by further comprising a cleaning step of cleaning the masking panel, after the separating step.
